(19) United States
(12) Patent Application Publication
(10) Pub. No.: US 2018/0087215 A1
(43) Pub. Date: Mar. 29, 2018

(54) MULTILAYER PRESPREG STRUCTURE AND METHOD OF MANUFACTURING THE SAME

(71) Applicants: HYUNDAI MOTOR COMPANY, Seoul (KR); KIA Motors Corporation, Seoul (KR); MUHAN CARBON CORP., Chungcheongbuk-do (KR)

(72) Inventors: Sang Yoon Park, Daejeon (KR); Hyo Jin Lee, Yongin-si (KR); Chi Hoon Choi, Suwon-si (KR); June Ho Yang, Seoul (KR); Byoung Chul Yoon, Seongnam-si (KR)

(73) Assignees: HYUNDAI MOTOR COMPANY, Seoul (KR); KIA Motors Corporation, Seoul (KR); MUHAN CARBON CORP., Chungcheongbuk-do (KR)

(21) Appl. No.: 15/376,028

(22) Filed: Dec. 12, 2016

(30) Foreign Application Priority Data
Sep. 29, 2016 (KR) 10-2016-0125807

(51) Int. Cl. D06M 15/55; D06M 13/345; D06M 13/432; B29C 70/16; B29C 70/44; B29C 65/18

(52) U.S. Cl. CPC D06M 15/55; D06M 13/345; D06M 13/432; D06M 2101/40; B29C 70/443; B29C 65/18; B29C 70/16

(57) ABSTRACT

Disclosed are a multilayer prepreg structure and a method of manufacturing the same. The multilayer prepreg structure includes a prepreg layer formed by impregnating a carbon fiber fabric with a first resin, and a fixed layer formed of a second resin having a higher curing rate than the first resin and provided on one surface of the prepreg layer.

### CROSS-REFERENCE TO RELATED APPLICATION

This application claims the priority benefit of Korean Patent Application No. 10-2016-0125807, filed on Sep. 29, 2016, in the Korean Intellectual Property Office, the disclosure of which is incorporated herein by reference.

### BACKGROUND OF THE INVENTION

### 1. Field of the Invention

The present invention relates to a multilayer prepreg structure and a method of manufacturing the same and, more particularly, to a multilayer prepreg structure having improved appearance quality and a method of manufacturing the same.

### 2. Description of the Related Art

In general, parts formed of Carbon Fiber Reinforced Plastic (CFRP) are manufactured to have a prepreg structure in which a fabric woven from carbon fibers is impregnated with a resin. CFRP has a low weight to strength ratio and a desirable appearance, and is thus useful as a vehicle interior material.

However, in conventional prepreg structures, the resin recedes from the surface layer of the carbon fiber fabric during the resin curing process resulting in unevenness on the surface of the prepreg structure. To flatten an uneven prepreg structure surface, a coating material may be repeatedly applied to the prepreg structure surface. Repeated application of the coating material increases both manufacturing time and manufacturing costs.

In addition, the diffusion of air bubbles remaining in the resin to the surface may cause pinholes resulting in defects in the appearance of the prepreg structure.

FIG. 1 is a cross-sectional view illustrating a conventional prepreg structure, and FIG. 2 is a view illustrating a process for manufacturing a conventional prepreg structure.

As shown in FIGS. 1 and 2, in order to manufacture a prepreg structure 10, a carbon fiber fabric is impregnated with a resin 12, vacuum-evacuated and then heated so that the resin 12 is thermohardened while exhausting air bubbles B.

During this process, the air bubbles B are exhausted from the inside of the resin 12 and thus pinholes may be formed. In addition, the resin 12 may leak from the side surfaces of the prepreg structure 10, thereby exposing the carbon fiber fabric 11.

When a clear coating layer 20 is applied to a prepreg structure 10 where the carbon fiber fabric 11 is exposed, the surface of the clear coating layer 20 is deformed along the shape of the carbon fiber fabric 11. This degrades appearance quality of prepreg structure 10, necessitating application of additional, and often repeated, clear coating to achieve planarization of the prepreg structure 10 surface.

Therefore, a novel prepreg structure, having a flat surface with an improved appearance quality, and a method of manufacturing the improved prepreg structure that requires fewer clearcoat applications are needed.

The above description has been provided to aid in understanding of the background of the present invention and should not be interpreted as conventional technology known to those skilled in the art.

### SUMMARY OF THE INVENTION

The present disclosure addresses the problems described above. It is an object of the present disclosure to provide an improved multilayer prepreg structure having a flat surface and a method of manufacturing the improved prepreg structure.

In an example embodiment, the improved multilayer prepreg structure includes a prepreg layer formed by impregnating a carbon fiber fabric with a first resin, and a fixed layer formed of a second resin having a higher curing rate than the first resin applied to one surface of the prepreg layer.

In further example embodiments, the thickness ratio of a one-ply prepreg layer to the fixed layer is 1:0.25˜1.

In further example embodiments, the thickness of the prepreg layer is 0.4 mm or less.

In further example embodiments, the first resin has a gel-time of 8-30 minutes at a temperature of 125 degrees Celsius, and the second resin has a gel-time of 2-10 minutes at a temperature of 125 degrees Celsius.

In further example embodiments, the first resin is an epoxy resin containing a dicyandiamide-based hardener, and the second resin is an epoxy resin containing a urea-based hardener.

The improved multilayer prepreg structure may further include a clear coating layer applied to the surface of the fixed layer.

The disclosure herein also describes example embodiments of a method of manufacturing an improved multilayer prepreg structure, the method including the steps of: weaving a carbon fiber fabric; manufacturing a prepreg layer by impregnating the carbon fiber fabric with a first resin; applying a fixed layer, formed of a second resin having a higher curing rate than the first resin, to one surface of the prepreg layer; vacuum-packing the prepreg layer having the fixed layer applied thereto; and heating the vacuum-packed prepreg layer and fixed layer within an autoclave.

In further example embodiments, the method also includes the step of stacking a plurality of prepreg layers, prior to application of the fixed layer.

In vacuum-packing the prepreg layer, the prepreg layer provided with the fixed layer applied thereto is placed in a vacuum bag, and then the pressure is reduced to 1 bar or less.

For the curing of the vacuum-packed prepreg structure, the vacuum-packed prepreg layer hwith the fixed layer applied thereto is cured for 45-90 minutes at a pressure of 3-7 bar and a temperature of 120-180° C.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view of a conventional prepreg structure;

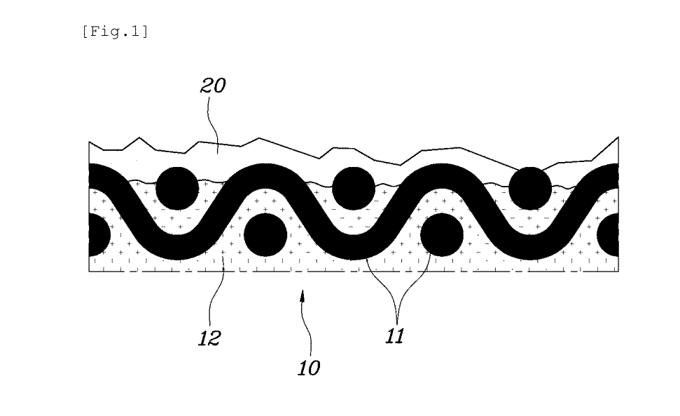

FIG. 2 is a view illustrating a process for manufacturing a conventional prepreg structure;

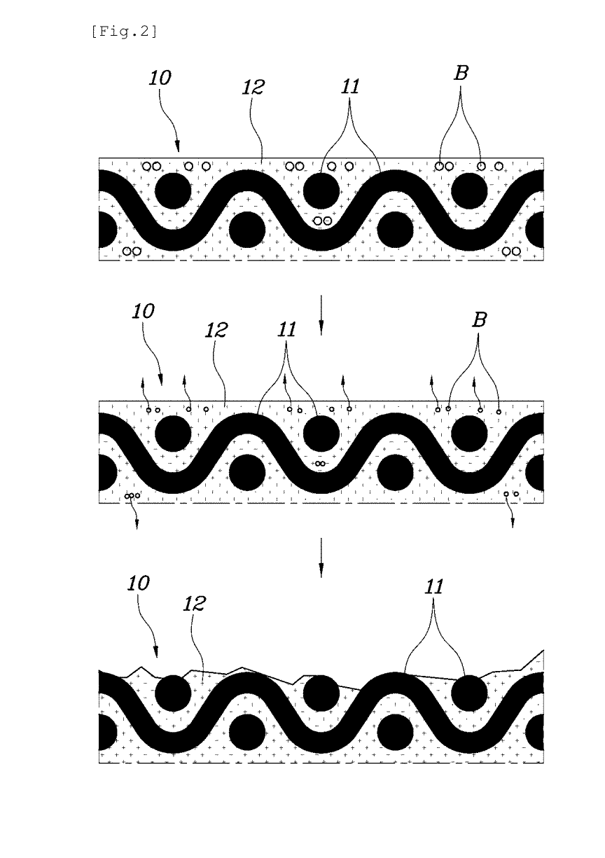

FIG. 3 is a cross-sectional view of an example embodiment of an improved multilayer prepreg structure;

FIG. 4 is a view illustrating an example embodiment of a process for manufacturing an improved multilayer prepreg structure;

FIG. 5 is a view illustrating an example embodiment of an improved multilayer prepreg structure in a vacuum-packed state during manufacture; and

FIGS. 6(a) to 6(c) are photographs of changes that occur in the appearance of a multilayer prepreg structure changed according to based on the curing rates of a second resin.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The technical terms used in the following descriptions are used only to describe specific embodiments but do not limit the present invention. The singular forms used herein include the plural forms unless stated otherwise. In the following description of the embodiments, the term “including” means materialization of a specific property, region, integer, step, operation, element and/or component, and does not exclude the presence or addition of other specific properties, regions, integers, steps, operations, elements, components and/or groups.

All terms including technical or scientific terms used herein have the same meanings as generally understood by those skilled in the art, unless stated otherwise. Terms generally defined in dictionaries should be interpreted as having meanings coinciding with contextual meanings in the related technology and meanings disclosed herein, and are not interpreted as having ideal or excessively formal meanings, unless defined clearly in the present invention.

Example embodiments of an improved multilayer prepreg structure and a method of manufacturing the same are described herein with reference to the accompanying drawings.

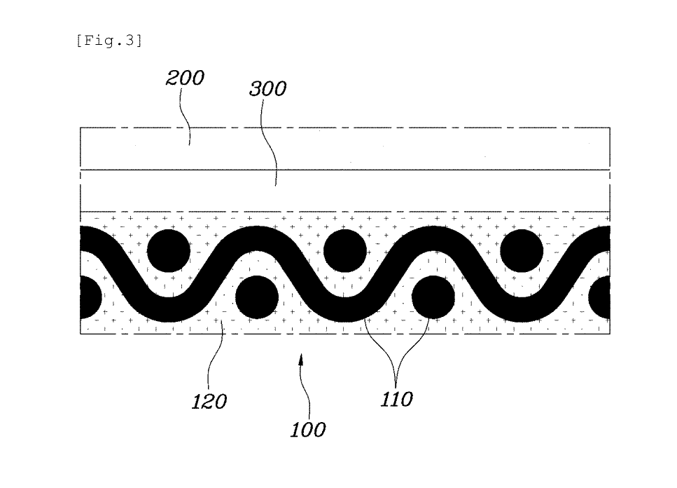

FIG. 3 schematically illustrates an example embodiment of an improved multilayer prepreg structure. The multiplayer prepreg structure includes a prepreg layer 100 comprising a carbon fiber fabric 110 impregnated with a first resin 120; a fixed layer 300 formed by a second resin and applied to one surface of prepreg layer 100, and a clear coating layer 200 applied to the fixed layer 300.

Carbon fiber fabric 110 is generally used to manufacture CFRP parts; therefore a detailed description of the processes for manufacturing carbon fiber fabric or creating specific patterns will be omitted.

In example embodiments, first resin 120 is an epoxy resin containing a dicyandiamide-based hardener and has a lower viscosity and lower curing rate than second resin.

First resin 120 has excellent flow characteristics and permeates the carbon fiber fabric 110 well, and is therefore advantageous in manufacturing of the prepreg structure. However, due to the low viscosity of first resin 120, when air bubbles remaining in first resin 120 are released during the curing process, first resin 120 may recede from the carbon fiber fabric 110. When air bubbles escape from first resin 120, thin pinholes may be generated, or the volume of first resin 120 may be reduced in some regions, exposing carbon fiber fabric 110 and creating an uneven surface for multilayer prepreg structure.

To solve the problem of exposure of the carbon fiber fabric 110, a fixed layer 300 including the second resin is applied to a surface of prepreg layer 100.

The second resin of fixed layer 300 has a higher curing rate than the first resin 120 of prepreg layer 100, hardens more rapidly than first resin 120 during the curing process, and forms a flat film on the surface layer of the multilayer prepreg structure.

In example emboidments, the second resin is an epoxy resin containing a urea-based hardener and has higher viscosity and a higher curing rate than the first resin 120.

When fixed layer 300 is applied to one surface of prepreg layer 100 and the multilayer prepreg structure is cured, fixed layer 300 hardend first, forming a hard film on the surface of the multilayer prepreg structure. Air bubbles B remaining in the first resin 120 do not escape through fixed layer 300, but instead escape the prepreg layer 100 through a surface of prepreg layer 100 opposite that to which fixed layer 300 was not applied. Therefore, application of fixed layer 300 prevents the generation of pinholes.

Thereafter, while first resin 120 hardens, the hardened fixed layer 300 serves as a support that prevents first resin 120 from receding from carbon fiber fabric 110 and prevents air bubbles B from escaping through the side surfaces of prepreg layer 100. This minimizes formation of voids or unevenness prepreg layer 100.

In example embodiments, the ratio of the thickness of prepreg layer 100 to the thickness of fixed layer 300 is between about 1:0.25 and about 1:1. If the thickness of fixed layer 300 is ¼ or less of the thickness of prepreg layer 100, first resin 120 is not properly fixed, and thus the carbon fiber fabric 110 is exposed. If the thickness of fixed layer 300 is greater than the thickness of prepreg layer 100, thermal damage to the multilayer prepreg structure may be caused by an asymmetric stack structure.

As long as prepreg layer 100 has a minimum necessary strength, the thickness of the prepreg layer 100 need not be specifically limited. However, large increases in the thickness of the prepreg layer 100 require stacking an excessively large amount of carbon fiber fabric; therefore, in the example embodiments disclosed herein the upper limit of the thickness of the prepreg layer 100 is set to 0.4 mm or less.

In further example embodiments, a clear coat layer 200 is applied after curing of prepreg layer 100 and fixed layer 300. Clear coat layer 200 serves to improve the overall appearance of the multilayer prepreg structure and to protect prepreg layer 100 and fixed layer 300.

The improved multilayer prepreg structure disclosed herein including prepreg layer 100 and fixed layer 300 has excellent flatness compared to the conventional prepreg structure, and therefore requires fewer applications of clear when applying clear coat layer 200.

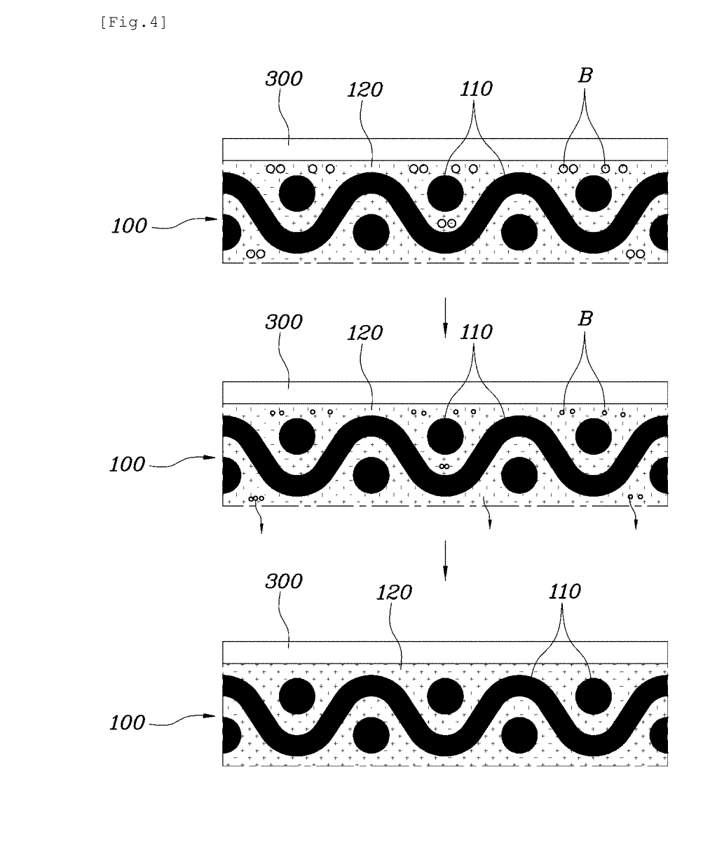

Example embodiments of a method of manufacturing an improved multilayer prepreg structure are described below with reference to FIGS. 3 to 5.

First, carbon fibers are woven into the carbon fiber fabric 110. Carbon fiber fabric 110 is then impregnated with first resin 120 to form prepreg layer 100. In on example embodiment, first resin 120 is an epoxy-based resin having a viscosity of 100-2,500 cPs prior to curing and a gel-time of 8-30 minutes at a temperature of 125° C.

Although a fixed layer 300 may be applied to a single prepreg layer 100, the overall appearance of the multilayer prepreg structure, and, in particular, the appearance of the pattern of the carbon fiber fabric 110, may be improved by stacking a plurality of prepreg layers 100. In accordance with one example embodiment, two prepreg layers 100 are stacked and the fixed layer 300 is applied to an exposed surface of one of the prepreg layers 100 to achieve the above effect.

Fixed layer 300, comprising a second resin having a higher curing rate than first resin 120, is applied one surface of prepreg layer 100. In an example embodiment, the second resin is an epoxy-based resin having a viscosity of 2,500-10,000 cPs prior to curing and a gel-time of 2-10 minutes at a temperature of 125° C.

In vacuum-packing, prepreg layer 100 having fixed layer 300 applied thereto is placed in a vacuum bag 430, and the inside of vacuum bag 430 is evacuated to reach a pressure of 1 bar or less, causing air bubbles remaining in first resin 120 to escape.

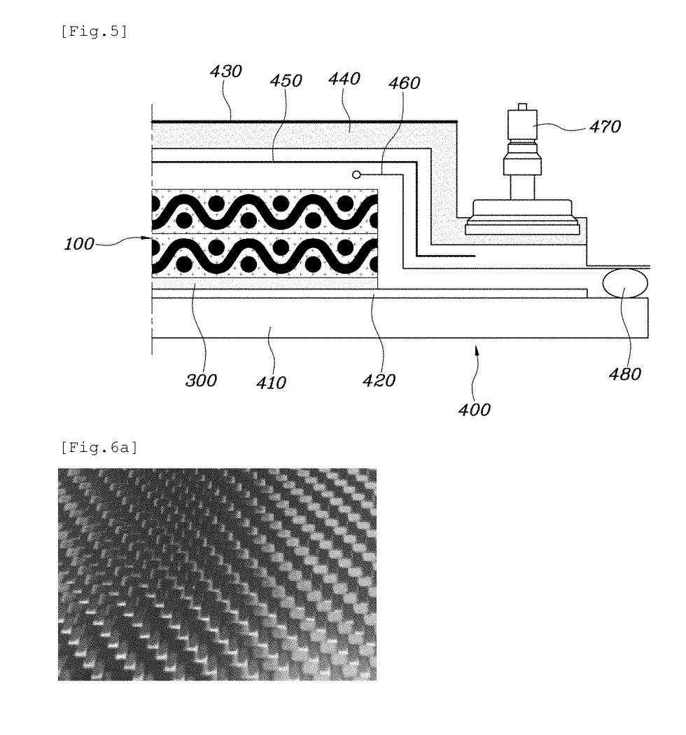

In this process, the surface of prepreg layer 100 having fixed layer 300 applied thereto, faces down and contacts a mold 410. Vacuum bag 430 is placed over the other surface of prepreg layer 100, and the gap between mold 410 and vacuum bag 430 is sealed with a sealant 480, as shown in FIG. 5.

A fabric breather 440 and a separation film 450 to prevent adhesion between the prepreg layer 100 and the breather 440 are positioned between vacuum bag 430 and prepreg layer 100. A vacuum port 470 is installed to allow evacuation of air from vacuum bag 430.

In further example embodiments, a separation material 420 may be positioned between mold 410 and fixed layer 300 to allow for easy separation of fixed layer 300 from mold 410. A thermocouple 460 to measure the temperature inside the vacuum bag 430 also may be installed.

The vacuum-bagged prepreg layer 100 having fixed layer 300 applied thereto may be simultaneously vacuum-packed and hot-pressed by placing vacuum bag 430 and mold 410 in an autoclave and then compressing at a pressure of 3-7 bar and heating to 120-180° C. for 45-90 minutes. This process thermally cures first resin 120 and second resin.

During this process, the second resin hardens first forming a film that serves as a supporter to prevent first resin 120 from receding from prepreg layer 100.

After the hot-pressing process is completed, hardened prepreg layer 100 and fixed layer 300 are removed from vacuum bag 430 and then coated with clear coating layer 200.

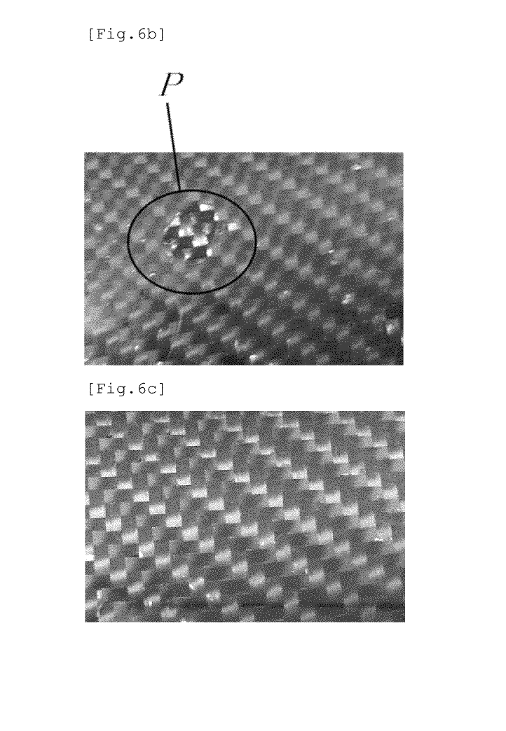

FIGS. 6(a) to 6(c) are photographs showing how the appearance of an example embodiment of an improved multilayer prepreg structure as described herein changes based on different curing rates for the second resin. FIG. 6(a) shows the appearance of an improved multilayer prepreg structure made using a second resin with a curing rate of 5-20 minutes. FIG. 6(b) shows the appearance of an improved multilayer prepreg structure made using a second resin with a curing rate of less than 5 minutes. FIG. 6(c) shows the appearance of an improved multilayer prepreg structure made using a second resin with a curing rate of more than 20 minutes.

As used herein, curing rate is defined as a point of time when the degree of resin curing, calculated using internal temperature change, is 90% or more, when the multilayer prepreg structure is heated at a heating rate of 5 degrees Celsius per minute using a differential scanning calorimetery (“DSC”) apparatus.

As shown in FIG. 6(a), if the curing rate of the second resin is 5-20 minutes, the multilayer prepreg structure has a smooth surface with no pinholes and high transparency.

In contrast, as shown in FIG. 6(b), if the curing rate of the second resin is less than 5 minutes, the viscosity of the second resin is excessively high and the resin does not adequately fill pinholes. Therefore the surface of the multilayer prepreg structure contains a large number of visible pinholes.

As shown in FIG. 6(c), if the curing rate of the second resin exceeds 20 minutes, the surface of the multilayer prepreg structure becomes opaque and uneven. Because in this example the curing rate of the second resin is similar to the curing rate of the resin of a conventional prepreg structure, viscosity of the second resin is lower, and the second resin may not serve to properly fix the first resin and prevent it from receding from the prepreg layer.

Therefore, in example embodiments, the curing rate of the second resin is set within the range of 5-20 minutes.

As is apparent from the above description, an improved multilayer prepreg structure and a method for manufacturing an improved multilayer prepreg structure exhibit the following characteristics.

First, applying fixed layer having a high curing rate to the surface layer of a prepreg structure improves surface flatness of the prepreg structure.

Second, applying the fixed layer having a high curing rate to the surface layer of a prepreg structure prevents generation of pinholes or voids due to recession of a resin from the inside of the prepreg.

Third, controlling the thickness of the applied fixed layer results in additional depth to the appearance of a CFRP part.

Fourth, application of the fixed layer having a high curing rate to the surface layer of a prepreg structure creates an aesthetically valuable CFRP part with a pattern formed by a carbon fiber fabric.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multilayer prepreg structure comprising:
a prepreg layer formed by impregnating a carbon fiber fabric with a first resin; and
a fixed layer formed of a second resin having a higher curing rate than the first resin and applied to a surface of the prepreg layer.

2. The multilayer prepreg structure according to claim 1, wherein the ratio of the thickness of the prepreg layer to the thickness of fixed layer is between about 1:0.25 and about 1:1.

3. The multilayer prepreg structure according to claim 2, wherein the thickness of the prepreg layer is 0.4 mm or less.

4. The multilayer prepreg structure according to claim 1, wherein:
the first resin has a gel-time of 8-30 minutes at a temperature of 125 degrees Celsius; and
the second resin has a gel-time of 2-10 minutes at a temperature of 125 degrees Celsius.

5. The multilayer prepreg structure according to claim 1, wherein:
the first resin is an epoxy resin containing a dicyandiamide-based hardener; and
the second resin is an epoxy resin containing a urea-based hardener.

6. The multilayer prepreg structure according to claim 1, further comprising a clear coat layer applied to a surface of the fixed layer.

7. A method of manufacturing a multilayer prepreg structure, the method comprising:
weaving a carbon fiber fabric;
impregnating the carbon fiber fabric with a first resin to form a prepreg layer;
applying a fixed layer, comprising a second resin having a higher curing rate than the first resin, to one surface of the prepreg layer;
vacuum-packing the prepreg layer hving the fixed layer applied thereto; and
hot-pressing the vacuum-packed prepreg layer within an autoclave.

8. The method according to claim 7, further comprising stacking a plurality of prepreg layers prior to application of the fixed layer, wherein the fixed layer is applied to a surface of the stacked prepreg layers.

9. The method according to claim 7, wherein the prepreg layer having the fixed layer applied thereto is placed in a vacuum bag and then the pressure is reduced to 1 bar or less.

10. The method according to claim 7, wherein the vacuum-packed prepreg layer is hot-pressed for 45-90 minutes under conditions of a pressure of 3-7 bar and a temperature of 120-180 degrees Celsius.
